(19) United States
(12) Patent Application Publication
(10) Pub. No.: US 2014/0135433 A1
(43) Pub. Date: May 15, 2014

(54) TIRE WITH RUBBER CONTAINING FLAVONE

(71) Applicant: The Goodyear Tire & Rubber Company, Akron, OH (US)

(72) Inventor: Paul Harry Sandstrom, Cuyahoga Falls, OH (US)

(73) Assignee: The goodyear Tire & Rubber Company, Akron, OH (US)

(21) Appl. No.: 13/674,978

(22) Filed: Nov. 13, 2012

(51) Int. Cl. C08K 5/1545; C08K 5/3492

(52) U.S. Cl. CPC C08K 5/1545; C08K 5/34922
USPC 524/100

(57) ABSTRACT

The invention relates to a pneumatic tire having a component containing a rubber composition comprising
(A) a diene based elastomer; and
(B) an adhesion promoter derived from
   (1) a flavone;
   (2) a methylene donor; and
   (3) a methylene acceptor;
wherein the rubber composition is essentially free of cobalt.

### BACKGROUND OF THE INVENTION

A tire is a composite of several components each serving a specific and unique function yet all synergistically functioning to produce the desired performance. In several tire components, an in-situ resin is included in a rubber composition to impart desirable properties to the rubber composition, including hardness, tear strength, and adhesion to reinforcement. Typically, methylene acceptor—methylene donor systems are used as in-situ resins in combination with cobalt to promote adhesion of the rubber to steel cords. Unfortunately, cobalt is undesirable from an environmental standpoint. Therefore, there exists a need for cobalt replacement without sacrificing the beneficial properties resulting from its use.

### SUMMARY OF THE INVENTION

The present invention relates to a pneumatic tire having a component containing a rubber composition comprising
(A) a diene based elastomer; and
(B) an adhesion promoter derived from
   (1) a flavone;
   (2) a methylene donor selected from the group consisting of hexamethylenetetramine, hexamethoxymethylmelamine, hexamethoxymethylmelamine, imino-methoxymethylmelamine, imino-isobutoxymethylmelamine, lauryloxymethylpyridinium chloride, ethoxymethylpyridinium chloride, trioxan hexamethoxymethylmelamine and N-substituted oxymethyl melamines of the formula:

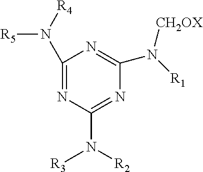

wherein X is selected from the group consisting of hydrogen and an alkyl having from 1 to 8 carbon atoms; and R₁, R₂, R₃, R₄ and R₅ are individually selected from the group consisting of hydrogen, an alkyl having from 1 to 8 carbon atoms, the group —CH₂OX and their condensation products; and
   (3) a methylene acceptor selected from the group consisting of resorcinol, resorcinolic derivatives, monohydric phenols and their derivatives, dihydric phenols and their derivatives, polyhydric phenols and their derivatives, unmodified phenol novolak resins, modified phenol novolak resins, phenol formaldehyde resins, and resorcinol novolak resins;
      wherein the rubber composition is essentially free of cobalt.

### DETAILED DISCLOSURE OF THE INVENTION

There is disclosed a pneumatic tire having a component containing a rubber composition comprising
(A) a diene based elastomer; and
(B) an adhesion promoter derived from
   (1) a flavone;
   (2) a methylene donor selected from the group consisting of hexamethylenetetramine, hexamethoxymethylmelamine, hexamethoxymethylmelamine, imino-methoxymethylmelamine, imino-isobutoxymethylmelamine, lauryloxymethylpyridinium chloride, ethoxymethylpyridinium chloride, trioxan hexamethoxymethylmelamine and N-substituted oxymethyl melamines of the formula:

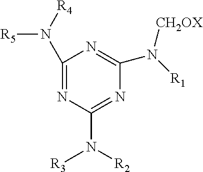

wherein X is selected from the group consisting of hydrogen and an alkyl having from 1 to 8 carbon atoms; and R₁, R₂, R₃, R₄ and R₅ are individually selected from the group consisting of hydrogen, an alkyl having from 1 to 8 carbon atoms, the group —CH₂OX and their condensation products; and
   (3) a methylene acceptor selected from the group consisting of resorcinol, resorcinolic derivatives, monohydric phenols and their derivatives, dihydric phenols and their derivatives, polyhydric phenols and their derivatives, unmodified phenol novolak resins, modified phenol novolak resins, phenol formaldehyde resins, and resorcinol novolak resins;
wherein the rubber composition is essentially free of cobalt.

The present invention relates to a pneumatic tire. Pneumatic tire means a laminated mechanical device of generally toroidal shape (usually an open torus) having beads and a tread and made of rubber, chemicals, fabric and steel or other materials. The present invention relates to both bias and radial-ply tires. Preferably, the present invention is a radial-ply tire. Radial-ply tire means a belted or circumferentially-restricted pneumatic tire in which the carcass ply cords which extend from bead to bead are laid at cord angles between 65° and 90° with respect to the equatorial plane of the tire.

The rubber composition for use in the tire component may contain a natural or synthetic diene derived rubber. Representative of the rubbers include medium vinyl polybutadiene, styrene-butadiene rubber, synthetic cis-1,4-polyisoprene, synthetic 3,4-polyisoprene, natural rubber, cis-polybutadiene, styrene-isoprene rubber, styrene-isoprene-butadiene rubber, acrylonitrile-butadiene rubber, carboxylated acrylonitrile-butadiene rubber and mixtures thereof. Preferably, the rubber is natural rubber, styrene-butadiene rubber or cis-polybutadiene.

The component of the tire of the present invention contains an adhesion promoter derived from a flavone, a methylene donor, and a methylene acceptor. The adhesion promoter is useful particularly in an application where a rubber composition must adhere to a metal surface. Such an application occurs in a pneumatic tire, for instance, wherein a rubber composition reinforced with a steel cord must have sufficient adhesion of the rubber composition to the steel cord.

A flavone is an essential component in the present invention. Such chemicals are commercially available from Indofine Chemical Company, Inc. Flavones are naturally occurring substances found in a variety of plants. Flavones are generally described by the formula (I),

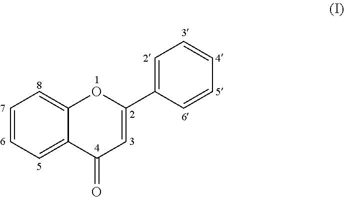 [SMILES: O=c1cc(-c2ccccc2)oc2ccccc12]

with various substitution of functional groups at the 1-8 and 2′-6′ ring carbons.

Flavones useful in the present invention may include one or more of the following: acacetin(5,7-dihydroxy-4′-methoxyflavone; linarigenin), amentoflavone trihydrate, amentoflavone-7,4,4′-trimethyl ether(sciadopitysin), apigenin (5,7,4′-trihydroxyflavone), apigenin-7-glucoside(apigetrin, cosmetin, cosmiin), apiin(apigenin-7-apioglucoside), avicularin (quercetin-3-arabinoside), baicalein(5,6,7-trihydroxyflavone), baicalein trimethyl ether(5,6,7-trimethoxyflavone), baicalin (baicalein-7-O-glucuronide), 5,6-benzoflavone(β-naphthoflavone), 7,8-benzoflavone(α-naphthoflavone), 3′-benzyloxy-5,7-dihydroxy-3,4′-dimethoxyflavone, 3′-benzyloxy-5,6,7,4′-tetramethoxyflavone, 6-bromo-4′-chloroflavone, 6-bromoflavone 8-carboxy-3-methylflavone(3-methylflavone-8-carboxylic acid), 4′-chloro-6,8-dibromoflavone, 4′-chloroflavone, 6-chloroflavone, 4′-chloro-6-methylflavone, 6-chloro-7-methylflavone, chrysoeriol, cupressuflavone trihydrate, datiscetin, datiscoside, 6,8-dibromoflavone, 6,4′-dichloroflavone, 6,8-dichloroflavone, 6,4′-dichloro-7-methylflavone, 3,7-dihydroxy-3′,4′-dimethoxyflavone(fisetin-3′,4′-dimethyl ether), 3,5-dihydroxyflavone, 3,6-dihydroxyflavone, 3,7-dihydroxyflavone, 3,2′-dihydroxyflavone, 3,3′-dihydroxyflavone, 5,7-dihydroxyflavone(chrysin), 5,2′-dihydroxyflavone, 5,3′-dihydroxyflavone, 5,4′-dihydroxyflavone, 6,7-dihydroxyflavone, 6,2′-dihydroxyflavone, 6,3′-dihydroxyflavone, 6,4′-dihydroxyflavone, 7,8-dihydroxyflavone, 7,2′-dihydroxyflavone, 7,3′-dihydroxyflavone, 7,4′-dihydroxyflavone, 2′,3′-dihydroxyflavone, 2′,4′-dihydroxyflavone, 3′,4′-dihydroxyflavone (4-hydroxyflavonol), 5,6-dihydroxy-7-methoxyflavone(baicalein-7-methyl ether), 5,4′-dihydroxy-7-methoxyflavone(genkwanin; 7-methoxyapigenin), 3′,4′-dihydroxy-a-naphthoflavone, 3′,4′-dihydroxy-b-naphthoflavone, 5,8-dihydroxy-3,7,3′,4′-tetramethoxyflavone(gossypetin 3,7,3′,4′-tetramethyl ether), 3,7-dihydroxy-3′,4′,5′-trimethoxyflavone(robinetin trimethyl ether), 5,3′-dihydroxy-6,7,4′-trimethoxyflavone(eupatorin), 5,7-dihydroxy-3′,4′,5′-trimethoxyflavone, 3,5-dimethoxyflavone, 3,6-dimethoxyflavone, 3,7-dimethoxyflavone, 3,2′-dimethoxyflavone, 3,3′-dimethoxyflavone, 3,4′-dimethoxyflavone, 5,7-dimethoxyflavone(dhrysin dimethyl ether), 5,2′-dimethoxyflavone, 5,3′-dimethoxyflavone, 5,4′-dimethoxyflavone, 6,7-dimethoxyflavone, 6,2′-dimethoxyflavone, 6,3′-dimethoxyflavone, 6,4′-dimethoxyflavone, 7,8-dimethoxyflavone, 7,2′-dimethoxyflavone, 7,3′-dimethoxyflavone, 7,4′-dimethoxyflavone, 2′,3′-dimethoxyflavone, 2′,4′-dimethoxyflavone, 3′,4′-dimethoxyflavone, 3′,4′-dimethoxyflavonol(3-hydroxy-3′,4′-dimethoxyflavone), 2′,3′-dimethoxy-3-hydroxyflavone, 2′,4′-dimethoxy-3-hydroxyflavone, 3′,4′-dimethoxy-a-naphthoflavone, 3′,4′-dimethoxy-b-naphthoflavone, 3,4′-dimethoxy-5,7,3′-trihydroxyflavone(5,7,3′-trihydroxy-3,4′-dimethoxyflavone), diosmetin, diosmin(barosmin, diosmetin-7-rutinoside), eupatorin-5-methyl ether, fisetin(3,7,3′,4′-tetrahydroxyflavone), flavone(2-Phenylchromone), fortunellin(acacetin-7-neohesperidoside), galangin(3,5,7-trihydroxyflavone), gardenin(5-hydroxy-6,7,8,3′,4′,5′-hexamethoxyflavone), geraldol, gossypetin(3,5,7,8,3′,4′-hexahydroxyflavone), gossypin(3,5,7,8,3′,4′-hexahydroxyflavone-8-glucoside), 5,6,7,3′,4′,5′-hexamethoxyflavone hinokiflavone(4′,6″-O-biapigenin), homoorientin(isoorientin), 6-hydroxyapigenin(scutellarein), 5-hydroxy-7,4′-dimethoxy-6,8-dimethylflavone(eucalyptin), 3-hydroxy-6,4′-dimethoxyflavone, 3-hydroxy-7,4′-dimethoxyflavone, 3-hydroxy-2′,4′-dimethoxy-6-methylflavone, 3-hydroxyflavone(flavonol), 5-hydroxyflavone(primuletin), 6-hydroxyflavone, 7-hydroxyflavone, 2′-hydroxyflavone, 3′-hydroxyflavone, 4′-hydroxyflavone, 6-hydroxyflavone-b-D-glucoside, 7-hydroxyflavone-b-d-glucoside(7-b-d-glucosyloxyflavone), 3-hydroxy-5-methoxyflavone (5-methoxyflavonol), 3-hydroxy-6-methoxyflavone(6-methoxyflavonol), 3-hydroxy-7-methoxyflavone(7-methoxyflavonol), 3-hydroxy-2′-methoxyflavone, 3-hydroxy-3′-methoxyflavone, 3-hydroxy-4′-methoxyflavone, 5-hydroxy-7-methoxyflavone(tectochrysin, methyl chrysin), 5-hydroxy-2′-methoxyflavone, 5-hydroxy-3′-methoxyflavone, 5-hydroxy-4′-methoxyflavone, 6-hydroxy-7-methoxyflavone, 6-hydroxy-2′-methoxyflavone, 6-hydroxy-3′-methoxyflavone, 6-hydroxy-4′-methoxyflavone, 7-hydroxy-2′-methoxyflavone, 7-hydroxy-3′-methoxyflavone, 7-hydroxy-4′-methoxyflavone(pratol), 8-Hydroxy-7-methoxyflavone, 4′-hydroxy-5-methoxyflavone, 4′-hydroxy-6-methoxyflavone, 4′-hydroxy-7-methoxyflavone, 4′-hydroxy-3′-methoxyflavone, 3-hydroxy-4′-methoxy-6-methylflavone, 3-hydroxy-6-methylflavone (6-methylflavonol), 7-hydroxy-3-methylflavone, 7-hydroxy-5-methylflavone, 2′-hydroxy-α-naphthoflavone, 2′-hydroxy-β-naphthoflavone, 4′-hydroxy-α-naphthoflavone, 4′-hydroxy-β-naphthoflavone, 5-hydroxy-3,7,3′,4′-tetramethoxyflavone(quercetin tetramethyl ether), 3′-hydroxy-5,6,7,4′-tetramethoxyflavone, 3-hydroxy-3′,4′,5′-trimethoxyflavone, 3-hydroxy-6,2′,3′-trimethoxyflavone, 3-hydroxy-6,2′,4′-trimethoxyflavone, 3-hydroxy-6,3′,4′-trimethoxyflavone, 3-hydroxy-7,2′,3′-trimethoxyflavone, 3-hydroxy-7,2′,4′-trimethoxyflavone, hyperoside with HPLC (hyperin, quercetin-3-galactoside), isoquercitrin(quercetin-3-glucoside), isorhamnetin, isorhamnetin-3-glucoside, isorhamnetin-3-rutinoside(narcisin), isorhoifolin(apigenin-7-rutinoside), isovitexin, kaempferide(3,5,7-trihydroxy-4′-methoxyflavone), kaempferide, kaempferol(3,5,7,4′-tetrahydroxyflavone), kaempferol-3-glucoside with HPLC (astragalin), kaempferol-7-neohesperidoside, kaempferol-3-rutinoside, kaempferol-3,7,4′-trimethylether, karanjin, linarin(acacetin-7-rutinoside), liquiritigenin monohydrate, luteolin(5,7,3′,4′-tetrahydroxyflavone), luteolin-7,3′-diglucoside, luteolin-4′-glucoside, luteolin-7-glucoside, maritimein, 3-methoxyflavone, 5-methoxyflavone, 6-methoxyflavone, 7-methoxyflavone, 2′-methoxyflavone, 3′-methoxyflavone, 4′-methoxyflavone, 4′-methoxyflavonol, 6-methoxyluteolin, 2′-methoxy-a-naphthoflavone(2′-methoxy-7,8-benzoflavone), 2′-methoxy-b-naphthoflavone, 4′-methoxy-a-naphthoflavone, 6-methylflavone, 8-methylflavone, 6-methyl-4′-methoxyflavone, 8-methyl-4′-methoxyflavone, morin, myricetin(cannabiscetin, 3,5,7,3′,4′,5′-hexahydroxyflavone), myricitrin dihydrate(myricetin-3-rhamnoside dihydrate), myricitrin(myricetin-3-rhamnoside), neodiosmin(diosmetin-7-neohesperidoside), orientin(luteolin-8-c-glucoside), peltatoside(quercetin-3-arabinoglucoside), 3,7,3′,4′,5′-pentahydroxyflavone(robinetin, 5-hydroxyfisetin), 3,7,3′,4′,5′-pentahydroxyflavone, 5,6,7,3′,4′-pentamethoxyflavone(sinensetin), 5,7,3′,4′,5′-pentamethoxyflavone, quercetagetin, quercetin dihydrate(3,5,7,3′,4′-pentahydroxyflavone dihydrate), quercetin, Quercetin-3-O-b-D-glucopyranosyl-6″-acetate, quercetin-3,5,7,3′,4′-pentamethyl ether(3,5,7,3′,4′-pentamethoxyflavone), quercetin-3-O-sulfate potassium salt, quercetin-3,7,3′,4′-tetramethyl ether(retusin), quercitrin(quercetin-3-rhamnoside), quercitrin, rhoifolin(apigenin-7-neohesperidoside, apigenin-7-rhamnoglucoside), rhoifolin, robinin(kaempferol-3-robinoside-7-rhamnoside), rutin trihydrate, rutin trihydrate, saponarin, scutellarein tetramethyl ether(5,6,7,4′-tetramethoxyflavone), spiraeoside, sulfuretin(6,3′,4′-Trihydroxyaurone), syringetin-3-galactoside, syringetin-3-glucoside, tamarixetin with HPLC (quercetin-4′-methylether, 4′-methoxy-3,5,7,3′-tetrahydroflavone), 3,5,7,4′-tetrahydroxy-3′,5′-dimethoxyflavone(syringetin), 3,6,2′,4′-tetrahydroxyflavone, 7,8,3′,4′-tetrahydroxyflavone, 3,5,3′,4′-tetrahydroxy-7-methoxyflavone(rhamnetin), 3,6,3′,4′-tetramethoxyflavone, 5,7,3′,4′-tetramethoxyflavone(luteolin tetramethyl ether), 7,8,3′,4′-tetramethoxyflavone tiliroside, 6,8,4′-trichloroflavone, 3,6,4′-trihydroxyflavone, 3,7,4′-trihydroxyflavone(5-deoxykampferol, resokaempferol), 3,3′,4′-trihydroxyflavone(3′,4′-dihydroxyflavonol), 5,7,8-trihydroxyflavone, 5,7,2′-trihydroxyflavone, 5,3′,4′-trihydroxyflavone, 6,3′,4′-trihydroxyflavone, 7,8,2′-trihydroxyflavone, 7,8,3′-trihydroxyflavone, 7,8,4′-trihydroxyflavone, 7,3′,4′-trihydroxyflavone, 3,5,7-trihydroxy-3′,4′,5′-trimethoxyflavone(myricetin trimethyl ether), 5,7,4′-trimethoxyflavone(apigenin trimethyl ether), 7,3′,4′-trimethoxyflavone, vitexin(apigenin-8-C-glucoside), vitexin-2″-O-rhamnoside(apigenin-8-C-glucoside-2′-rhamnoside).

In an alternative embodiment, the flavone includes one or more of kaempferol(3,5,7,4′-tetrahydroxyflavone), quercetin(3,5,7,3′,4′-pentahydroxyflavone), myricetin(3,5,7,3′,4′,5′-hexahydroxyflavone), apigenin(5,7,4′-trihydroxyflavone), and luteolin(5,7,3′,4′-tetrahydroxyflavone). In one embodiment, the flavone is quercetin.

In one embodiment, the amount of flavone included in the adhesion promoter ranges from 1 to 20 phr. In one embodiment, the amount of flavone included in the adhesion promoter ranges from 1 to 10 phr.

In-situ resins are formed as part of the adhesion promoter in the rubber composition and involve the reaction of a methylene acceptor and a methylene donor.

In one embodiment, the rubber composition contains from 2 to 35 phr of the reaction product of a methylene acceptor and a methylene donor. In one embodiment, from 5 to 15 phr of the reaction product is used.

The term “methylene acceptor” is known to those skilled in the art and is used to describe the reactant to which the methylene donor reacts to form what is believed to be a methylol monomer. The condensation of the methylol monomer by the formation of a methylene bridge produces the resin. The initial reaction that contributes the moiety that later forms into the methylene bridge is the methylene donor wherein the other reactant is the methylene acceptor. Representative compounds which may be used as a methylene acceptor include but are not limited to resorcinol, resorcinolic derivatives, monohydric phenols and their derivatives, dihydric phenols and their derivatives, polyhydric phenols and their derivatives, unmodified phenol novolak resins, modified phenol novolak resin, phenol formaldehyde resin, resorcinol novolak resins and mixtures thereof. Examples of methylene acceptors include but are not limited to those disclosed in U.S. Pat. No. 6,605,670; U.S. Pat. No. 6,541,551; U.S. Pat. No. 6,472,457; U.S. Pat. No. 5,945,500; U.S. Pat. No. 5,936,056; U.S. Pat. No. 5,688,871; U.S. Pat. No. 5,665,799; U.S. Pat. No. 5,504,127; U.S. Pat. No. 5,405,897; U.S. Pat. No. 5,244,725; U.S. Pat. No. 5,206,289; U.S. Pat. No. 5,194,513; U.S. Pat. No. 5,030,692; U.S. Pat. No. 4,889,481; U.S. Pat. No. 4,605,696; U.S. Pat. No. 4,436,853; and U.S. Pat. No. 4,092,455. Examples of modified phenol novolak resins include but are not limited to cashew nut oil modified phenol novolak resin, tall oil modified phenol novolak resin and alkyl modified phenol novolak resin. In one embodiment, the methylene acceptor is a reactive phenol-formaldehyde resin. Suitable reactive phenol-formaldehyde resins include SMD 30207 from Schenectedy Chemicals.

Other examples of methylene acceptors include activated phenols by ring substitution and a cashew nut oil modified novolak-type phenolic resin. Representative examples of activated phenols by ring substitution include resorcinol, cresols, t-butyl phenols, isopropyl phenols, ethyl phenols and mixtures thereof. Cashew nut oil modified novolak-type phenolic resins are commercially available from Schenectady Chemicals Inc under the designation SP6700. The modification rate of oil based on total novolak-type phenolic resin may range from 10 to 50 percent. For production of the novolak-type phenolic resin modified with cashew nut oil, various processes may be used. For example, phenols such as phenol, cresol and resorcinol may be reacted with aldehydes such as formaldehyde, paraformaldehyde and benzaldehyde using acid catalysts. Examples of acid catalysts include oxalic acid, hydrochloric acid, sulfuric acid and p-toluenesulfonic acid. After the catalytic reaction, the resin is modified with the oil.

The amount of methylene acceptor in the rubber stock may vary. In one embodiment, the amount of methylene acceptor ranges from 1 to 25 phr. In another embodiment, the amount of methylene acceptor ranges from 2 to 20 phr.

In-situ resins are formed in the rubber stock and involve the reaction of a methylene acceptor and a methylene donor. The term “methylene donor” is intended to mean a compound capable of reacting with the methylene acceptor and generate the resin in-situ. Examples of methylene donors which are suitable for use in the present invention include hexamethylenetetramine, hexamethoxymethylmelamine, hexaethoxymethylmelamine, imino-methoxymethylmelamine, imino-isobutoxymethylmelamine, lauryloxymethylpyridinium chloride, ethoxymethylpyridinium chloride trioxan and hexamethoxymethylmelamine. In addition, the methylene donors may be N-substituted oxymethylmelamines, of the general formula:

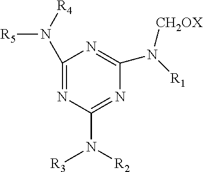

wherein X is hydrogen or an alkyl having from 1 to 8 carbon atoms, R₁′ R₂, R₃, R₄ and R₅ are individually selected from the group consisting of hydrogen, an alkyl having from 1 to 8 carbon atoms, the group —CH2OX or their condensation products. Specific methylene donors include hexakis-(methoxymethyl)melamine, N,N′,N″-trimethyl/N,N′,N″-trimethylolmelamine, hexamethylolmelamine, N,N′,N″-dimethylolmelamine, N-methylolmelamine, N,N′-dimethylolmelamine, N,N′,N″-tris(methoxymethyl)melamine and N,N′N″-tributyl-N,N′,N″-trimethylol-melamine. The N-methylol derivatives of melamine are prepared by known methods.

The amount of methylene donor that is present in the adhesion promoter may vary. In one embodiment, the amount of methylene donor that is present will range from about 1 phr to 25 phr. In one embodiment, the amount of methylene donor ranges from about 2 phr to 20 phr.

It is readily understood by those having skill in the art that the rubber compositions used in tire components would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

The rubber compound may contain various conventional rubber additives. Typical additions of carbon black comprise about 20 to 200 parts by weight of diene rubber (phr), preferably 50 to 100 phr.

A number of commercially available carbon blacks may be used. Included in the list of carbon blacks are those known under the ASTM designations N299, S315, N326, N330, M332, N339, N343, N347, N351, N358, N375, N539, N550 and N582. Such processing aids may be present and can include, for example, aromatic, naphthenic, and/or paraffinic processing oils. Typical amounts of tackifying resins, such as phenolic tackifiers, range from 1 to 3 phr. Silica, if used, may be used in an amount of about 5 to about 80 phr, often with a silica coupling agent. Representative silicas may be, for example, hydrated amorphous silicas. Typical amounts of antioxidants comprise about 1 to about 5 phr. Representative antioxidants may be, for example, diphenyl-p-phenylenediamine, polymerized 1,2-dihydro-2,2,4-trimethylquinoline and others, such as, for example, those disclosed in the Vanderbilt Rubber Handbook (1990), Pages 343 through 362. Typical amounts of antiozonants comprise about 1 to about 5 phr. Representative antiozonants may be, for example, those disclosed in the Vanderbilt Rubber Handbook (1990), Pages 363 through 367. Typical amounts of fatty acids, if used, which can include stearic acid comprise about 0.5 to about 3 phr. Typical amounts of zinc oxide comprise about 2 to about 10 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide. The presence and relative amounts of the above additives are considered to be not an aspect of the present invention which is more primarily directed to the utilization of the combination of the reaction product of the flavone and methylene donor.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents are used in an amount ranging from about 0.5 to about 5 phr, or even, in some circumstances, up to about 8 phr, with a range of from about 3 to about 5 being preferred.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging from about 0.5 to about 2.5 phr. In another embodiment, combinations of two or more accelerators which is generally used in the larger amount (0.5 to 2.0 phr), and a secondary accelerator which is generally used in smaller amounts (0.05 to 0.50 phr) in order to activate and to improve the properties of the vulcanizate. Combinations of these accelerators have been known to produce a synergistic effect of the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The rubber composition, as noted, excludes cobalt. However, as is known in the art some residual amount of cobalt may be present in mixing equipment and consequently appear in rubber compositions. The rubber composition is then said to be essentially free of cobalt. By essentially free, it is meant that the amount of cobalt, if any, is very low and is present only due to contamination by process equipment and normal handling in the material procurement process. In one embodiment, the amount of cobalt is less than 0.1 phr. In one embodiment, the amount of cobalt is less than 0.05 phr. In one embodiment, the about of cobalt is less than 0.01 phr.

The rubber composition may be described as consisting essentially of a diene based elastomer, and an adhesion promoter derived from a flavone, a methylene acceptor, and a methylene donor. In this instance, by “consisting essentially of ” means that while other typical compounding additives as described herein may be present in the rubber composition, cobalt and cobalt salts are not included as they have a material and undesirable effect on the behavior of the rubber composition in the sense that they have an undesirable environmental effect.

The tire can be built, shaped, molded and cured by various methods which will be readily apparent to those having skill in such art.

The prepared tire of this invention is conventionally shaped and cured by methods known to those having skill in such art.

The invention may be better understood by reference to the following examples in which the parts and percentages are by weight unless otherwise indicated.

### EXAMPLE 1

In this example, the effect of replacing a cobalt salt with quercetin is demonstrated for rubber compounds containing carbon black and a methylene acceptor/methylene donor resin. Four experimental rubber compounds were prepared in a lab Banbury mixer as indicated in Table 1. Physical properties of the compounds were evaluated as indicated in Table 2.

TABLE 1

| Sample No. | A | B | C | D |
|---|---|---|---|---|
| Sample Type | control | compare | inventive | invent |
| First Non-Productive | | | | |
| Mixing Stage | | | | |
| Cis-1,4-polyisoprene rubber¹ | 100 | 100 | 100 | 100 |
| Carbon black | 60 | 60 | 60 | 60 |
| Silica | 5 | 5 | 5 | 5 |
| Processing oil | 2 | 2 | 2 | 2 |
| Fatty acid | 1 | 1 | 1 | 1 |
| Zinc oxide | 7 | 7 | 7 | 7 |
| Cobalt Salt² | 0.5 | 0 | 0 | 0 |
| Quercetin | 0 | 0 | 3 | 5 |
| Productive Mixing Stage | | | | |
| Sulfur³ | 5 | 5 | 5 | 5 |
| Accelerators | 1 | 1 | 1 | 1 |
| Phenol/formaldehyde resin⁴ | 3 | 3 | 3 | 3 |
| Hexamethoxymethylmelamine | 4.17 | 4.17 | 4.17 | 4.17 |

¹75/25 blend of natural rubber and NAT2200 from The Goodyear Tire & Rubber Company
²Cobalt neodecanoate
³Insoluble sulfur, 80% active
⁴SMD 30207 from Schenectedy Chemicals

TABLE 2

| | A | B | C | D |
|---|---|---|---|---|
| Rheometer¹, 150° C. | | | | |
| Minimum torque (dNm) | 3.89 | 4.0 | 4.77 | 4.65 |
| Delta torque (dNm) | 40.8 | 38.1 | 38.9 | 37.0 |
| T₉₀ (minutes) | 23.9 | 34.2 | 31.9 | 32.1 |
| Stress-strain ATS (cured | | | | |
| 35 minutes at 155° C.) | | | | |
| Tensile strength (MPa) | 18.4 | 17.3 | 16.6 | 12.0 |
| Elongation at break (%) | 373 | 353 | 309 | 242 |
| 100% modulus (MPa) | 5.1 | 4.6 | 5.1 | 4.6 |
| Rebound, 100° C. (%) | 51 | 53 | 56 | 56 |
| Hardness, 100° C. | 83 | 78 | 76 | 73 |
| Tear strength², N/mm | 94 | 85 | 77 | 71 |
| (95° C.) | | | | |
| Wire Adhesion³ (cured | | | | |
| 35 minutes at 155° C.) | | | | |
| Original at room | 664 | 494 | 646 | 704 |
| temperature, N | | | | |
| Rubber coverage, % | 85 | 45 | 80 | 90 |
| Aged 10 days in water | 673 | 733 | 817 | 810 |
| at 90° C., N | | | | |
| Rubber coverage, % | 20 | 60 | 70 | 70 |
| Aged 10 days in N₂ at | 825 | 727 | 815 | 787 |
| 120° C., N | | | | |
| Rubber coverage, % | 85 | 75 | 95 | 95 |
| Monsanto RPA 1%, | | | | |
| 100° C., 1 hz | | | | |
| G′, uncured | 285 | 211 | 328 | 335 |
| G′ at 1% strain (KPa) | 11013 | 10094 | 9071 | 7867 |
| G′ at 10% strain (KPa) | 3870 | 3651 | 3859 | 3255 |
| Tan delta at 10% strain | 0.242 | 0.238 | 0.205 | 0.219 |

¹Cure properties were determined using a Monsanto oscillating disc rheometer (MDR) which was operated at a temperature of 150° C. and at a frequency of 11 hertz. A description of oscillating disc rheometers can be found in The Vanderbilt Rubber Handbook edited by Robert O. Ohm (Norwalk, Conn., R. T. Vanderbilt Company, Inc., 1990), Pages 554 through 557. The use of this cure meter and standardized values read from the curve are specified in ASTM D-2084. A typical cure curve obtained on an oscillating disc rheometer is shown on Page 555 of the 1990 edition of The Vanderbilt Rubber Handbook.
²The hot tear resistance property (tear strength) determination is conducted for peel adhesion of a sample to another sample of the same material. A description may be found in ASTM D4393 except that a sample width of 2.5 cm is used and a clear Mylar plastic film window of a 5 mm width is inserted between the two test samples. It is an interfacial adhesion measurement (pulling force expressed in N/mm units) between two layers of the same tested compound which have been co-cured together with the Mylar film window therebetween. The purpose of the Mylar film window is to delimit the width of the pealed area. The DRI property can be determined by the formula: DRI = (G′/(300 percent modulus)) × (100)). This property is considered herein to be measure, or indication of the cracking and tear propagation resistance of the compound.
³Standard wire and textile cord adhesion tests (SWAT) were conducted by embedding a single cord in the respective rubber compositions. The rubber articles were then cured as indicated. The cord in these rubber compositions were then subjected to a pull-out test, according to ASTM Standard D2229-73.
⁴Viscoelastic properties Tan Delta and G′ were measured using an Alpha Technologies Rubber Process Analyzer (RPA). A description of the RPA 2000, its capability, sample preparation, tests and subtests can be found in these references. H A Pawlowski and J S Dick, Rubber World, June 1992; J S Dick and H A Pawlowski, Rubber World, January 1997; and J S Dick and J A Pawlowski, Rubber & Plastics News, Apr. 26 and May 10, 1993.

As seen in Tables 1 and 2, the replacement of cobalt with quercetin in a methylene donor/methylene acceptor containing rubber composition results in equal or superior adhesion to wire, in both original and aged samples.

While the embodiments described herein have been directed to a rubber composition and a tire, the present invention is not so limited. The rubber composition may also be used in various applications, including but not limited to power transmission belts, hoses, tracks, tires, air sleeves, and conveyor belts.

While certain representative embodiments and details have been shown for the purpose of illustrating the subject invention, it will be apparent to those skilled in this art that various changes and modifications can be made therein without departing from the scope of the subject invention.

What is claimed is:

1. A pneumatic tire having a component containing a rubber composition consisting essentially of
(A) a diene based elastomer; and
(B) an adhesion promoter derived from
(1) a flavone;
(2) a methylene donor selected from the group consisting of hexamethylenetetramine, hexamethoxymethylmelamine, hexamethoxymethylmelamine, imino-methoxymethylmelamine, imino-isobutoxymethylmelamine, lauryloxymethylpyridinium chloride, ethoxymethylpyridinium chloride, trioxan hexamethoxymethylmelamine and N-substituted oxymethyl melamines of the formula: 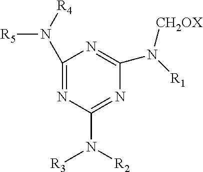
wherein X is selected from the group consisting of hydrogen and an alkyl having from 1 to 8 carbon atoms; and R₁, R₂, R₃, R₄ and R₅ are individually selected from the group consisting of hydrogen, an alkyl having from 1 to 8 carbon atoms, the group —CH₂OX and their condensation products; and
(3) a methylene acceptor selected from the group consisting of resorcinol, resorcinolic derivatives, monohydric phenols and their derivatives, dihydric phenols and their derivatives, polyhydric phenols and their derivatives, unmodified phenol novolak resins, modified phenol novolak resins, phenol formaldehyde resins, and resorcinol novolak resins;
wherein the rubber composition is essentially free of cobalt.

2. A pneumatic tire having a component containing a rubber composition comprising
(A) a diene based elastomer; and
(B) an adhesion promoter derived from
(1) a flavone;
(2) a methylene donor selected from the group consisting of hexamethylenetetramine, hexamethoxymethylmelamine, hexamethoxymethylmelamine, imino-methoxymethylmelamine, imino-isobutoxymethylmelamine, lauryloxymethylpyridinium chloride, ethoxymethylpyridinium chloride, trioxan hexamethoxymethylmelamine and N-substituted oxymethyl melamines of the formula: 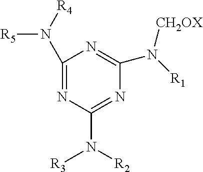
wherein X is selected from the group consisting of hydrogen and an alkyl having from 1 to 8 carbon atoms; and R₁, R₂, R₃, R₄ and R₅ are individually selected from the group consisting of hydrogen, an alkyl having from 1 to 8 carbon atoms, the group —CH₂OX and their condensation products; and
(3) a methylene acceptor selected from the group consisting of resorcinol, resorcinolic derivatives, monohydric phenols and their derivatives, dihydric phenols and their derivatives, polyhydric phenols and their derivatives, unmodified phenol novolak resins, modified phenol novolak resins, phenol formaldehyde resins, and resorcinol novolak resins;
wherein the rubber composition is essentially free of cobalt.

3. The tire of claim 2 wherein the diene based elastomer is selected from the group consisting of medium vinyl polybutadiene, styrene-butadiene rubber, synthetic cis-1,4-polyisoprene, synthetic 3,4-polyisoprene, natural rubber, cis-polybutadiene, styrene-isoprene rubber, styrene-isoprene-butadiene rubber, acrylonitrile-butadiene rubber, carboxylated acrylonitrile-butadiene rubber and mixtures thereof.

4. The tire of claim 2 wherein the amount of flavone ranges from 1 to 20 phr.

5. The tire of claim 2, wherein the amount of methylene donor ranges from 1 to 25 phr.

6. The tire of claim 2, wherein the amount of methylene acceptor ranges from 1 to 25 phr.

7. The tire of claim 2 wherein the amount of cobalt is less than 0.1 phr.

8. The tire of claim 2, wherein the amount of cobalt is less than 0.01 phr.

9. The tire of claim 2 wherein the flavone is selected from the group consisting of kaempferol(3,5,7,4′-tetrahydroxyflavone), quercetin(3,5,7,3′,4′-pentahydroxyflavone), myricetin(3,5,7,3′,4′,5′-hexahydroxyflavone), apigenin(5,7,4′-trihydroxyflavone), and luteolin(5,7,3′,4′-tetrahydroxyflavone) and mixtures thereof.

10. The tire of claim 2 wherein the flavone is quercetin.

11. A rubber composition comprising
(A) a diene based elastomer; and
(B) an adhesion promoter derived from
(1) a flavone;
(2) a methylene donor selected from the group consisting of hexamethylenetetramine, hexamethoxymethylmelamine, hexamethoxymethylmelamine, imino-methoxymethylmelamine, imino-isobutoxymethylmelamine, lauryloxymethylpyridinium chloride, ethoxymethylpyridinium chloride, trioxan hexamethoxymethylmelamine and N-substituted oxymethyl melamines of the formula: 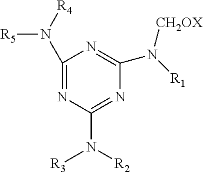
wherein X is selected from the group consisting of hydrogen and an alkyl having from 1 to 8 carbon atoms; and R₁, R₂, R₃, R₄ and R₅ are individually selected from the group consisting of hydrogen, an alkyl having from 1 to 8 carbon atoms, the group —CH₂OX and their condensation products; and
(3) a methylene acceptor selected from the group consisting of resorcinol, resorcinolic derivatives, monohydric phenols and their derivatives, dihydric phenols and their derivatives, polyhydric phenols and their derivatives, unmodified phenol novolak resins, modified phenol novolak resins, phenol formaldehyde resins, and resorcinol novolak resins;
wherein the rubber composition is essentially free of cobalt.

12. The composition of claim 11 wherein said rubber is selected from the group consisting of medium vinyl polybutadiene, styrene-butadiene rubber, synthetic cis-1,4-polyisoprene, synthetic 3,4-polyisoprene, natural rubber, cis-polybutadiene, styrene-isoprene rubber, styrene-isoprene-butadiene rubber, acrylonitrile-butadiene rubber, carboxylated acrylonitrile-butadiene rubber and mixtures thereof.

13. The composition of claim 11 wherein the amount of flavone ranges from 1 to 20 phr

14. The composition of claim 11, wherein the amount of methylene donor ranges from 1 to 25 phr.

15. The composition of claim 11, wherein the amount of methylene acceptor ranges from 1 to 25 phr.

16. The composition of claim 11 wherein the amount of cobalt is less than 0.01 phr.

17. The composition of claim 11 wherein the amount of cobalt is less than 0.1 phr.

18. The composition of claim 11 wherein said flavone is selected from the group consisting of kaempferol(3,5,7,4′-tetrahydroxyflavone), quercetin(3,5,7,3′,4′-pentahydroxyflavone), myricetin(3,5,7,3′,4′,5′-hexahydroxyflavone), apigenin(5,7,4′-trihydroxyflavone), and luteolin(5,7,3′,4′-tetrahydroxyflavone) and mixtures thereof.

19. The composition of claim 11 wherein said flavone is quercetin.

20. The composition of claim 11, wherein said rubber composition is a component of a power transmission belt, hose, track, tire, air sleeve, or conveyor belt.
